(19) United States
(12) Patent Application Publication
(10) Pub. No.: US 2009/0172334 A1
(43) Pub. Date: Jul. 2, 2009

(54) Data sorting device and method thereof

(76) Inventor: Wen-Bin Wang, Shengang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,635

(22) Filed: Jul. 25, 2008

(30) Foreign Application Priority Data
Dec. 26, 2007 (TW) 96150278

(51) Int. Cl. G06F 13/00; G06F 12/00

(52) U.S. Cl. 711/167; 711/E12.001

(57) ABSTRACT

A data sorting device and a method thereof are disclosed, wherein the data sorting device includes plural storage modules and an enabling controller. Moreover, each storage module has a falling edge-triggered register and a rising edge-triggered register, and each storage module receives a serial data in response to the rising edge of clock and the falling edge of clock. Furthermore, the enabling controller is connected with each storage module for enabling each storage module by sequence turns in response to the trigger of the rising edge of clock.

### BACKGROUND OF THE INVENTION

1. Field of the Invention

The present invention is related to a data sorting device and a method thereof, and more particularly to a device and a method for maintaining the correct sorting of serial data under DDR (Double Data Rate) transmission.

2. Description of the Related Art

Please refer to FIG. 1, which is a schematic view showing the conventional shift register. The shift register 1 is constituted by a first register 10, a second register 12, a third register 14 and a fourth register 16, and is a 4-bit shift register. The shift register 1 is triggered by clock clk1 or clk2 for receiving serial data serial_data, and then, the received serial_data is submitted to output terminals Q0˜Q3. However, since the serial data serial_data submitted to the output terminals Q0˜Q3 is triggered by the flip flop in the shift register in response to different phase clocks clk, this might cause the serial data to be outputted in an altered data sort.

Please refer to FIG. 2, which shows the clocks. When the first data S1 of the serial data serial_data is transmitted, owing to different trigger phases, the clock is divided into clock clk1 and clock clk2. When the first data S1 of the serial data serial_data is triggered by the falling edge of clock clk1 at time t0, the first data S1 will be transmitted to the second register 12, and when the second data S2 of the serial data serial_data is triggered by the rising edge of clock clk1 at time t1, the second data will be transmitted to the first register 10. Then, when the third data S3 of the serial data serial_data is triggered by the falling edge of clock clk1 at time t2, the third data will be transmitted to the second register 12, and the first data S1 in the second register 12 will be transmitted to the fourth register 16. Continuously, when the fourth data S4 of the serial data serial_data is triggered by the rising edge of clock clk1 at time t3, the fourth data will be transmitted to the first register 10, and the second data S2 in the first register 10 will be transmitted to the third register 14. Therefore, at time t3, the serial data serial_data collected by the shift register 1 and submitted to the output terminals Q0˜Q3 of the registers 10˜16 may have a sequence of S4, S3, S2, S1.

Moreover, when the first data S1 of the serial data serial_data is triggered by the rising edge of clock clk2, the first data S1 will be transmitted to the first register 10 at time t0, and when the second data S2 of the serial data serial_data is triggered by the falling edge of clock clk2, the second data S2 will be transmitted to the second register 12 at time t1. Then, when the third data S3 of the serial data serial_data is triggered by the rising edge of clock clk2, the third data S3 will be transmitted to the first register 10 at time t2, and the first data S1 in the first register 10 will be transmitted to the third register 14. Continuously, when the fourth data S4 of the serial data serial_data is triggered by the falling edge of clock clk2, the fourth data S4 will be transmitted to the second register 12 at time t3, and the second data S2 in the second register 12 will be transmitted to the fourth register 16. Therefore, at time t3, the serial data serial_data collected by the shift register 1 and submitted to the output terminals Q0˜Q3 of the registers 10˜16 may have a sequence of S3, S4, S1, S2.

Consequently, when utilizing the shift register 1 to collect serial data serial_data, the sequence of the serial data collected by the shift register 1 might be changed since the first data S1 might be triggered by the rising edge or the falling edge of clock. For solving this problem, an additional phase detector is used for detecting the clock phase. However, the cost is also increased.

Thus, under SMIA (Standard Mobile Imaging Architecture) standard, for avoiding from using the phase detector, it defines that under DDR transmission, the first data S1 of the serial data serial_data has to be triggered by the falling edge of clock.

However, only if the first data S1 is not triggered by the falling edge of clock owing to any accident of transmitter, substrate, board or system, the sort of the serial data serial_data will be disordered, so that a success decryption for producing synchronization code from the serial data serial_data can not be achieved, thereby causing the whole system disordered and uncovered.

### SUMMARY OF THE INVENTION

The object of the present invention is to provide a data sorting device and a method thereof for maintaining the correct sort of serial data under DDR (Double Data Rate) transmission, so as to solve the problem that the sort of the serial data might be altered since the first data S1 of the serial data might be triggered by the falling edge or the rising edge of clock.

The present invention provides a data sorting device including plural storage modules and an enabling controller, wherein each storage module has a falling edge-triggered register and a rising edge-triggered register, and each storage module is triggered by a rising edge of a clock and a falling edge of the clock to receive a serial data, and the enabling controller is connected with each storage module for enabling each storage module in turn in response to the trigger of the rising edge of the clock.

In the data sorting device described above, the enabling controller is utilized to enable the first storage module in response to the trigger of the falling edge of the clock. If the first data of the serial data obeys the SMIA standard, the first data will be transmitted through the trigger of the falling edge of clock, the second data will be transmitted through the trigger of the rising edge of clock, the third data will be transmitted through the trigger of the falling edge of clock, and so forth, wherein after the even-th data of the serial data serial_data is transmitted, the enabling controller will enable the next storage module (the second storage module), so that the serial data serial_data can have a sequence identical to the inputted serial data serial_data.

In another aspect, if the first data of the serial data serial_data does not obey the SMIA standard, the first data will be transmitted through the trigger of the rising edge of clock, the second data will be transmitted through the trigger of the falling edge of clock, the third data will be transmitted through the trigger of the rising edge of clock, and so forth, wherein after the odd-th data of the serial data serial_data is transmitted, the enabling controller will enable the next storage module (the second storage module), so that the serial data serial_data can still have a sequence identical to the inputted serial data serial_data.

Consequently, according to the present invention, the method of utilizing the rising edge of the clock to trigger the enabling controller to enable each storage module can maintain the correct sort of serial data without the extra phase detector even when the transmission does not obey the SMIA standard.

### BRIEF DESCRIPTION OF THE DRAWINGS

The foregoing aspects and many of the attendant advantages of this application will be more readily appreciated as the same becomes better understood by reference to the following detailed description, when taken in conjunction with the accompanying drawings, wherein:

FIG. 1 is a schematic view showing the architecture of conventional shift register;

FIG. 2 shows the clock phases;

FIG. 3 is a schematic view showing the architecture of data sorting device according to the present invention;

FIG. 4 shows the clock phases;

FIG. 5 is a flow chart showing the method for sorting serial data according to the present invention; and

FIG. 6 is another flow chart showing the method for sorting serial data according to the present invention.

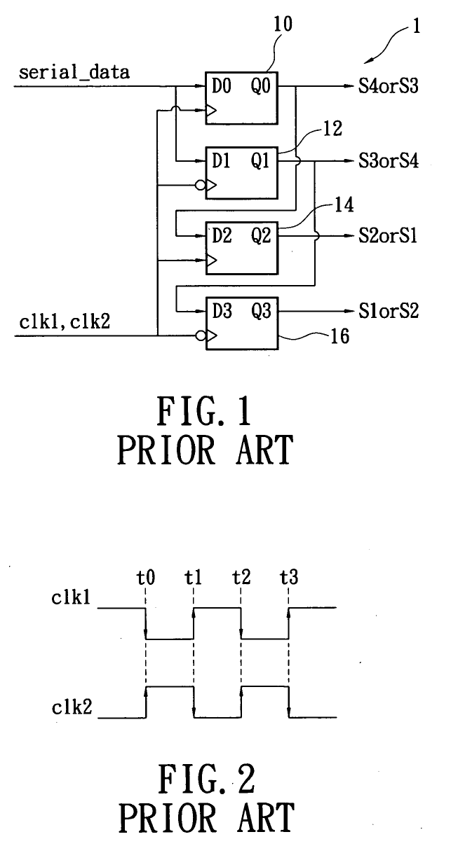

### DETAILED DESCRIPTION OF PREFERRED EMBODIMENTS

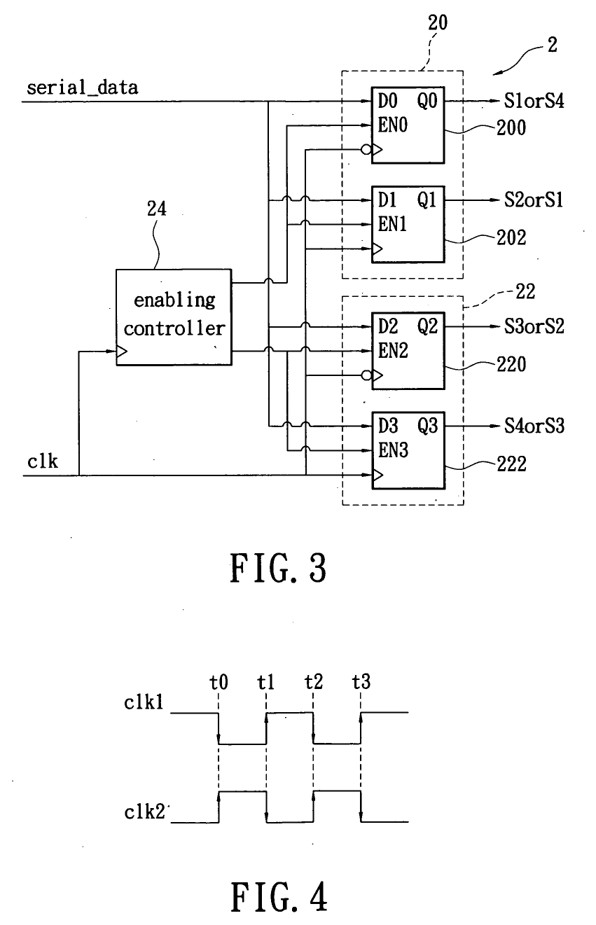

Please refer to FIG. 3, which is a schematic view showing a data sorting device according to the present invention. In this embodiment, it takes the 4 bit output as example. The data sorting device 2 includes a first storage module 20, a second storage module 22 and an enabling controller 24. However, it should be noted that for increasing the number of output bit, the number of storage module also should be increased.

Please refer to FIG. 3. The first storage module 20 include a first falling edge-triggered register 200 and a first rising edge-triggered register 202, wherein the registers 200, 202 are both D-typed flip flop. The first falling edge-triggered register 200 is triggered by the falling edge of a clock clk, so as to receive a serial data serial_data, and the first rising edge-triggered register 202 is triggered by the rising edge of the clock clk, so as to receive the serial data serial_data.

Furthermore, the second storage module 22 include a second falling edge-triggered register 220 and a second rising edge-triggered register 222, wherein the registers 220, 222 are both D-typed flip flop. The second falling edge-triggered register 220 is triggered by the falling edge of the clock clk, so as to receive the serial data serial_data, and the second rising edge-triggered register 222 is triggered by the rising edge of the clock clk, so as to receive the serial data serial_data. Besides, the enabling controller 24 is connected to the first storage module 20 and the second storage module 22, and can enable the first storage module 20 and the second storage module 22 in turn in response to the rising edge of the clock clk.

Please refer to FIG. 4, which shows the clock phase, wherein owing to different trigger phases, when the first data S1 of the serial data serial_data is transmitted, the clock is divided into clock clk1 and clock clk2. The first data S1 of the serial data serial_data is transmitted under SMIA standard and triggered by the falling edge of the clock clk1, and the first storage module 20 is enabled, so that at time t0, the first data S1 is transmitted to the first falling edge-triggered register 200. Then, the second data S2 of the serial data serial_data is triggered by the rising edge of clock clk1 at time t1 and is transmitted to the first rising edge-triggered register 202. In addition, in response to the trigger of the rising edge of the clock clk1, the enabling controller 24 enables the second storage module 22.

Moreover, the third data S3 of the serial data serial_data is triggered by the falling edge of clock clk1 at time t2, and is transmitted to the second falling edge-triggered register 220. Then, at time t3, the fourth data S4 of the serial data serial_data is triggered by the rising edge of clock clk1, and is transmitted to the second rising edge-triggered register 222. Therefore, at time t3, the serial data serial_data collected by the data sorting device 2 and submitted the output terminals Q0˜Q3 of the first storage module 20 and the second storage module 22 can have a sequence of S1, S2, S3, S4.

In another aspect, when the first data S1 of the serial data serial_data is not transmitted under SMIA standard and is triggered by the falling edge of the clock clk2, the first data S1 will be transmitted to the first rising edge-triggered register 202 at time t0, and in response to the trigger of the rising edge of the clock clk2, the enabling controller 24 enables the second storage module 22. Then, the second data S2 of the serial data serial_data is triggered by the falling edge of clock clk2 at time t1 and is transmitted to the second falling edge-triggered register 220. Then, the third data S3 of the serial data serial_data is triggered by the rising edge of clock clk2 at time t2 and is transmitted to the second rising edge-triggered register 222, and again, in response to the trigger of the rising edge of clock clk2, the enabling controller 24 enables the second storage module 22. Then, at time t3, the fourth data S4 of the serial data serial_data is triggered by the falling edge of clock clk2, and is transmitted to the first falling edge-triggered register 200. Therefore, at time t3, the serial data serial_data collected by the data sorting device 2 and submitted to the output terminals Q0˜Q3 of the first storage module 20 and the second storage module 22 can have a sequence of S4, S1, S2, S3.

Accordingly, if the first data S1 of serial data serial_data obeys the SMIA standard, the first data S1 will be transmitted through the trigger of the falling edge of clock clk1, the second data S2 will be transmitted through the trigger of the rising edge of clock clk1, the third data S3 will be transmitted through the trigger of the falling edge of clock clk1, and so forth, wherein after the even-th data of the serial data serial_data is transmitted, the enabling controller 24 will enable the second storage module 22, so that the serial data serial_data outputted at the output terminals Q0˜Q3 of the first storage module 20 and the second storage module 22 can have a sequence identical to the inputted serial data serial_data.

In another aspect, if the first data S1 of the serial data serial_data does not obey She MIA standard, the first data S1 will be transmitted through the trigger of the rising edge of clock clk2, the second data S2 will be transmitted through the trigger of the falling edge of clock clk2, the third data S3 will be transmitted through the trigger of the rising edge of clock clk2, and so forth, wherein after the odd-th data of the serial data serial_data is transmitted, the enabling controller 24 will enable the first storage module 20, so that the serial data serial_data outputted at the output terminals Q0˜Q3 of the first storage module 20 and the second storage module 22 can still have a sequence identical to the inputted serial data serial_data.

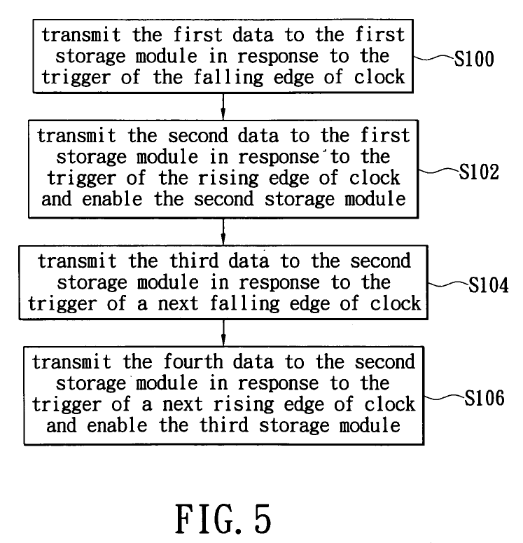

Please refer to FIG. 5, which is a flow chart showing the method for sorting the serial data according to the present invention. In this method, first, under SMIA standard, the first data S1 is transmitted to the first storage module by the trigger of the falling edge of clock (S100). Then, in response to the trigger of the rising edge of clock, the second data S2 is transmitted to the first storage module, and at the same time, the rising edge of clock enables the second storage module (S102). Then, in response to the trigger of the next falling edge of clock, the third data S3 is transmitted to the enabled second storage module (S104). Finally, in response to the trigger of the next rising edge of clock, the fourth data S4 is transmitted to the second storage module, and the third storage module is also enabled (S106). In accordance with this method, under SMIA standard, if the serial data including S1˜SN data is transmitted, the sequence in transmission will be S1, S2, S3, S4 . . . SN.

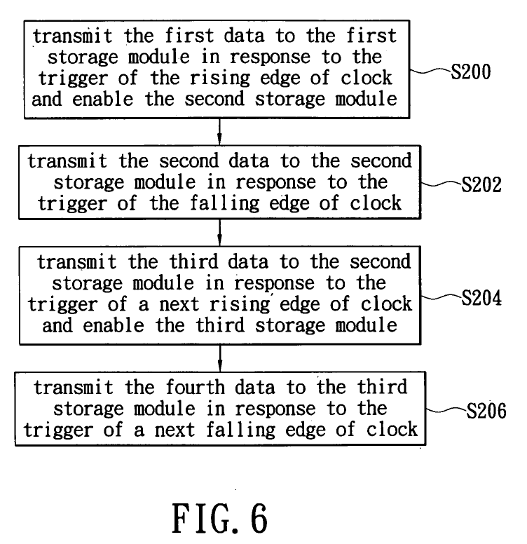

Please refer to FIG. 6, which is another flow chart showing the method for sorting serial data according to the present invention. First, without obeying SMIA standard, the first data S1 is transmitted to the first storage module by the trigger of the rising edge of clock, and at the same time, the rising edge of clock enables the second storage module (S200). Then, in response to the trigger of the falling edge of clock, the second data S2 is transmitted to the second storage module (S202). Then, in response to the trigger of the next rising edge of clock, the third data S3 is transmitted to the enabled second storage module, and at the same time, the rising edge of clock enables the third storage module (S204). Finally, in response to the trigger of the next falling edge of clock, the fourth data S4 is transmitted to the third storage module (S206). In accordance with this method, without obeying SMIA standard, if the serial data including S1˜SN data is transmitted, the sequence in transmission still will be S1, S2, S3, S4 . . . SN.

In the aforesaid, the present invention provides a data sorting device and a method thereof which utilizes the architecture and operation procedure of robust for sorting the serial signal produced by SubLVDS sequence, so that even the first data of the serial signal does not obey the SMIA standard due to accident (triggered by falling edge of clock), the whole serial data still can maintain the original sequence without phase detector.

Consequently, the data sorting device and the method thereof provided by the present invention can maintain a correct sort of serial data under DDR transmission, so as to solve the problem that the sequence sort of the first data may change due to the transmission thereof is triggered by the rising edge or by the falling edge of clock, and at the same time, to omit the phase detector.

It is to be understood, however, that even though numerous characteristics and advantages of the present application have been set forth in the foregoing description, together with details of the structure and function of the application, the disclosure is illustrative only, and changes may be made in detail, especially in matters of shape, size, and arrangement of parts within the principles of the application to the full extent indicated by the broad general meaning of the terms in which the appended claims are expressed.

What is claimed is:

1. A data sorting device, comprising:
plural storage modules, each storage module having a falling edge-triggered register and a rising edge-triggered register, and each storage module being triggered by a rising edge of a clock and a falling edge of the clock to receive a serial data; and
an enabling controller, connected with each storage module, for enabling each storage module in sequence turn in response to the trigger of the rising edge of the clock.

2. The data sorting device as claimed in claim 1, wherein in response to the trigger of the falling edge of the clock, the falling edge-triggered register of the first storage module receives a first data, and in response to the trigger of the rising edge of the clock, the rising edge-triggered register of the first storage module receives a second data.

3. The data sorting device as claimed in claim 2, wherein in response to the trigger of a next falling edge of the clock, the falling edge-triggered register of the second storage module receives a third data, and in response to the trigger of a next rising edge of the clock, the rising edge-triggered register of the second storage module receives a fourth data.

4. The data sorting device as claimed in claim 1, wherein in response to the trigger of the rising edge of the clock, the rising edge-triggered register of the first storage module receives a first data.

5. The data sorting device as claimed in claim 4, wherein in response to the trigger of the falling edge of the clock, the falling edge-triggered register of the second storage module receives a second data, and in response to the trigger of a next rising edge of the clock, the rising edge-triggered register of the first storage module receives a third data.

6. The data sorting device as claimed in claim 1, wherein the falling edge-triggered register and the rising edge-triggered register are D-typed flip flops.

7. A method for sorting serial data applied to multiple storage modules, wherein each storage module comprises an odd-th (odd number) register and an even-th (even number) register, the method comprising steps of:
transmitting an odd-th data of a serial data to the odd-th register in response to the trigger of a falling edge of a clock; and
transmitting an even-th data of the serial data to the even-th register in response to the trigger of a rising edge of the clock.

8. The method as claimed in claim 7, wherein a first data of the serial data is transmitted to a first odd-th register of a first storage module in response to the trigger of the falling edge of the clock, and a third data of the serial data is transmitted to a second odd-th register of a second storage module in response to the trigger of a next falling edge of the clock.

9. The method as claimed in claim 8, wherein in response to the trigger of the rising edge of the clock, a second data of the serial data is transmitted to a first even-th register of the first storage module and the second storage module is enabled, and in response to the trigger of a next rising edge of the clock, a fourth data of the serial data is transmitted to a second even-th register of the second storage module and the third storage module is enabled.

10. The method as claimed in claim 9, wherein the first odd-th register and the second odd-th register are falling edge-triggered registers.

11. The method as claimed in claim 9, wherein the first even-th register and the second even-th register are rising edge-triggered registers.

12. The method as claimed in claim 7, wherein in response to the trigger of the rising edge of the clock, a first data of the serial data is transmitted to a first even-th register of a first storage module and a second storage module is enabled, and in response to the trigger of a next rising edge of the clock, a third data of the serial data is transmitted to a second even-th register of a second storage module and the third storage module is enabled.

13. The method as claimed in claim 12, wherein in response to the trigger of the falling edge of the clock, a second data of the serial data is transmitted to a second odd-th register of the second storage module, and in response to the trigger of a next fall edge of the clock, a fourth data of the serial data is transmitted to the third storage module.

14. The method as claimed in claim 13, wherein the first odd-th register and the second odd-th register are falling edge-triggered registers.

15. The method as claimed in claim 13, wherein the first even-th register and the second even-th register are rising edge-triggered registers.
